(19) United States
(12) Patent Application Publication
(10) Pub. No.: US 2008/0000138 A1
(43) Pub. Date: Jan. 3, 2008

(54) Active fishing rod

(76) Inventor: Duane E. Cummings, Monticello, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 11/478,407

(22) Filed: Jun. 28, 2006

(51) Int. Cl. A01K 87/00; A01K 97/00

(52) U.S. Cl. 43/18.1 R; 43/25; 43/4

(57) ABSTRACT

A fishing rod is electronically enhanced to improve sensitivity and transmit to the user information related to conditions below the water surface in at or near real time.

### BACKGROUND OF THE INVENTION

I. Field of the Invention

The present invention relates to fishing rods. More particularly, the present invention provides a sensor, an amplifier, logic circuit and a vibrating mechanism for increasing the sensitivity of a fishing rod to provide the user with an indication of conditions at the end of a submerged fishing line used with the fishing rod.

II. Related Art

For centuries the sport of fishing has been performed using a pole with a line attached to it. Typically tied to the end of the line is a lure or bait to attract the fish and a hook to catch a fish attracted by the bait or lure.

In recent years, fishing rod manufacturers have adopted a variety of rod designs using a variety of composite materials such as graphite to provide rods that are strong, durable, comfortable to use, and sensitive. Many rods currently being manufactured are sensitive enough to permit the user to detect when a fish strikes the bait in most conditions. However, fishing enthusiasts continue to crave a rod that is even more sensitive, a rod that will permit the user to detect when a strike or nibble has occurred even in the most adverse conditions. Fishing enthusiasts have other interests related to sensitivity as well. They want to be able to sense underwater current conditions or when the lure or bait comes in contact with the bottom, vegetation, or other underwater structures. Even the most sensitive rods are only modestly successful in sensing and transmitting such information to the user.

### SUMMARY OF THE INVENTION

The present invention increases the sensitivity of a fishing rod electronically. Specifically, the present invention provides a sensor attached to the rod itself near the handle. This sensor can be a strain gauge, a bend sensor, a piezo-electric sensor providing a voltage output proportional to strain when the sensor is bent, or virtually any other type of sensor that senses strain or bend (referred to herein collectively as deflection) of the rod. The sensor is electronically coupled to a control circuit in the handle. The control circuit receives signals from the sensor, processes those signals, and responds to those signals in accordance with a predetermined set of instructions and pre-selected thresholds. The control circuit sends control signals to a vibrating motor or solenoid also located in the handle which causes the handle to vibrate based upon the signals received from the strain sensor and the programmed set of instructions and the pre-selected thresholds. The user can interpret such vibration. Certain vibrations tell the user whether there has been a nibble or strike at the end of the line. Other vibrations convey information regarding current conditions or whether the bottom or other submerged structures have been contacted by the bait, lure or hook used with the fishing rod.

### BRIEF DESCRIPTION OF THE DRAWINGS

FIG. 1 shows a fishing rod coupled to the electronic circuit of the present invention.

FIG. 2 is a schematic diagram of an electronic circuit made in accordance with the present invention.

FIG. 3 is a simplified schematic diagram of an electronic circuit made in accordance with the present invention.

FIG. 4 shows the embodiment of FIG. 3 which has been supplemented to include a summing circuit.

### DETAILED DESCRIPTION

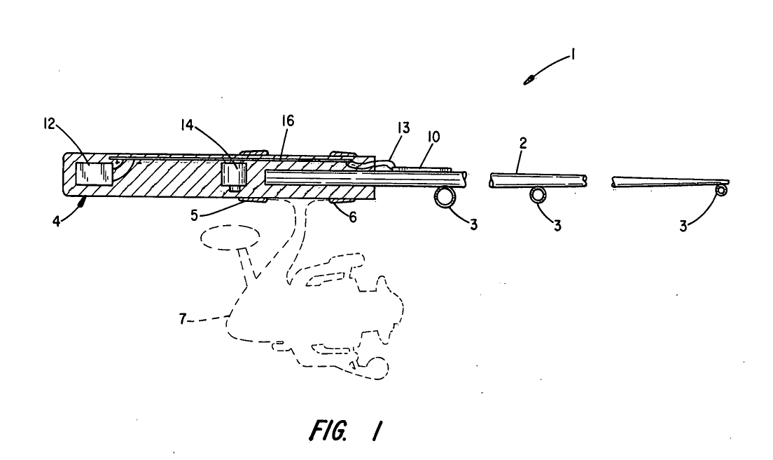

FIG. 1 generally shows a fishing rod 1. The rod includes a blank 2, a guide 3, a handle 4, a reel seat 5 and associated clamp 6 coupling a reel 7 to the rod 1. FIG. 1 also shows a sensor 10 coupled to the blank 2 adjacent the handle 4 and an electrical connection 13 between the sensor 10 and a control board 16 located within the handle.

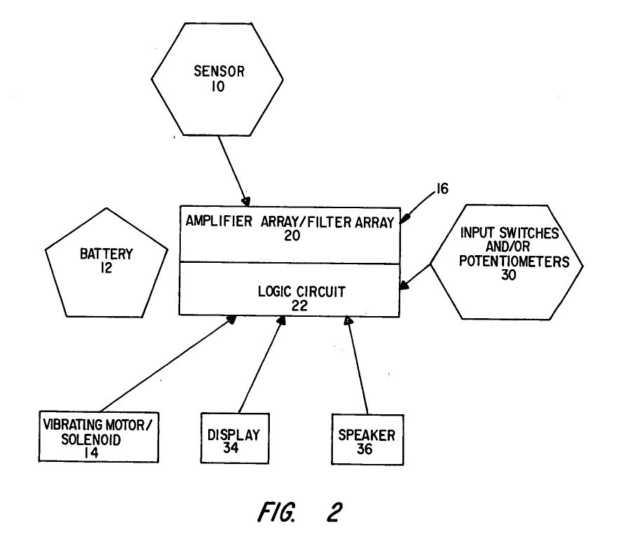

FIG. 2 is a block diagram showing the sensor 10, a battery 12, and a vibrating motor or solenoid 14 all electrically coupled to a control board 16. In one form, the control board includes an amplifier array 20 for amplifying signals generated by the strain sensor 10 and transmitting the amplified signals to a logic circuit (e.g., a microprocessor or other digital processor) 22. The logic circuit 22 processes these amplified signals in accordance with a predetermined set of instructions which may be stored in the programmable memory of the logic circuit 22 itself or in a separate memory (not shown) coupled to and controlled by the logic circuit 22. Certain advantages are achieved by filtering the signals transmitted by the amplifier array 20 to the logic circuit 22. This filtering can be performed by the amplifier array 20, the logic circuit 22 or a separate filter (not shown) between the amplifier array 20 and the logic circuit 22.

The vibrating motor or solenoid 14 is controlled by the logic circuit 22 and causes the handle 4 to vibrate in various ways in real time (or near real time) in response to what is sensed by the sensor 10. The battery 12 is used to supply electrical power as needed to the other components of the invention.

While in its simplest form, there is no need for the user to adjust the thresholds used by the logic circuit 22 in carrying out the predetermined set of instructions, the invention can also provide a mechanism for reprogramming or adjusting the parameters for these thresholds. For example, one or more input switches or potentiometers 30 could be embedded into the handle 4 and electrically coupled to the logic circuit 22, the battery 12 or the amplifier 20. Such switches or potentiometers could be used to turn the power on and off, adjust the gain of the amplifier 20 or adjust the characteristics of the output signals to the motor/solenoid 14.

The circuit can include a display 34. This display can be used to indicate different modes of operation, sensitivity settings, threshold settings, battery levels and other relevant information.

In some situations, the user may prefer to receive audible signals related to the operation of the active rod. Thus, FIG. 2 shows a speaker 36 coupled to and controlled by the logic circuit 22.

When in use, the sensor 10 continuously monitors deflection (i.e., strain or bend). The sensor 10 supplies a signal to the amplifier 20 indicative of any change in the amount of deflection of the blank 2 of the fishing rod 1. The amplifier array 20 amplifies these signals and forwards them to the logic circuit 22. The logic circuit 22 processes the signals it receives from the amplifier array pursuant to a programmed set of instructions and established parameters. The logic circuit 22 then sends output signals to the vibrating motor or solenoid 26 which in turn causes the handle to vibrate with varying degrees of intensity. Changes in the intensity of such vibrations indicate or signal to one holding the handle of the rod when a fish has struck or is nibbling on the bait or when objects in the water or the bottom are contacted by the bait or lure. The programming of the logic circuit 22 may also be designed to cancel the effect that the vibrating motor or solenoid 26 has on the sensor 10.

As indicated above, signals from the logic circuit 22 can also control a display 34 to provide various visual queues and information to the user. An audible alarm 36 could also be coupled to the logic circuit and sounded when a fish is nibbling on or has struck the bait.

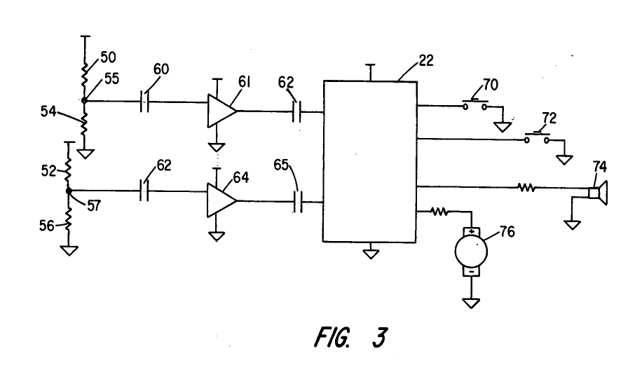

FIG. 3 is a simple schematic diagram of a circuit made in accordance with the present invention. In this embodiment, two sensors are shown. Each sensor is coupled to the battery 12 and a common ground. As shown, there are two fixed resistors 50 and 52 and two sensors 54 and 56 associated with two separate channels 55 and 57. The sensor 54 senses rod deflection along the up/down axis. The sensor 56 senses deflection along the left/right axis. Additional sensors and channels could be added to sense deflection along other axes or for improved accuracy. As shown, the first channel 55 carries signals generated by the sensor 54 via a capacitor 60, an amplifier 61 and another capacitor 62 to a microprocessor 22. The second channel 57 likewise carries signals generated by the sensor 56 via a capacitor 63, and amplifier 64 and another capacitor 65 to the microprocessor 22. The microprocessor 22 compares the signals received from the first channel 55 and second channel 57 in calculating the deflection (i.e., strain and bending) of the blank 2 of the fishing rod.

As mentioned above, other types of sensors can be used. In the case of piezo-electric sensors, the sensor serves as a voltage source providing a voltage proportional to deflection of the rod. This voltage can be supplied to a suitable amplifier or to the logic circuit directly depending upon the voltage generated. A separate piezo-electric sensor and channel will generally be used for each axis of possible deflection of interest.

In the embodiment shown in FIG. 3, a sensitivity control switch 70 and a mode control switch 72 are provided. Also provided are a speaker 74 and a vibration motor 76. The mode control switch can be used to set whether the microprocessor will sound the speaker 74, run the vibration motor 76, or both if the microprocessor 22 determines from the signals it receives that a predetermined parameter has been met. The sensitivity control switch 70 permits the user to adjust the parameter used by the microprocessor 22 to determine whether the speaker 74 and/or vibration motor 76 should be activated.

When the vibrating motor 76 is activated by the microprocessor 22, the handle of the fishing rod vibrates. This vibration of the handle emulates the movement of the rod tip in an accentuated fashion. It also serves to signal the person holding the handle. The vibrating motor 76 can, of course, be replaced with any number of devices capable of providing a mechanical or electrical indication through the handle to the user gripping the handle.

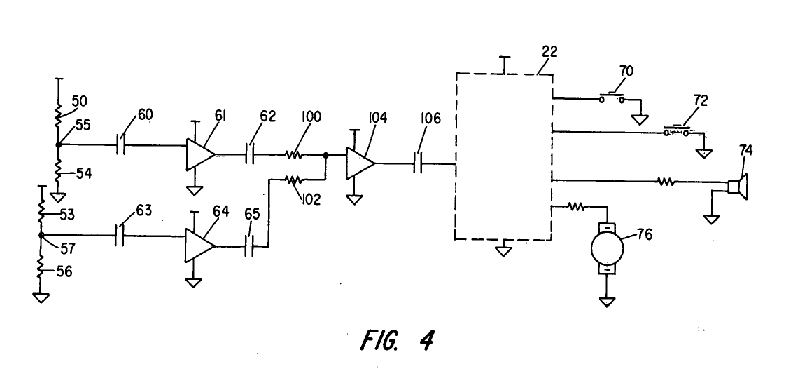

FIG. 4 shows an alternative embodiment. In this alternative embodiment, a summing circuit is provided. As shown, the summing circuit includes resistors 100 and 102, an amplifier 104 and capacitor 106 have been added to what is shown in FIG. 3. This summing circuit adds the output of the first (up/down) and second (right/left) channels 55 and 57. This provides the microprocessor with a signal representative of overall deflection in any given direction. In the embodiment shown in FIG. 3, the microprocessor, itself, could serve as the summing circuit such that summing could be performed under software controlled by the microprocessor 22.

The foregoing describes various embodiments of the present invention to comply with the disclosure requirements of the patent act. This discussion is not intended to be limiting. Instead it is intended to describe the best mode in sufficient detail to enable those of ordinary skill in the art to practice the invention. The scope of the invention is limited only by the following claims.

What is claimed is:

1. An active fishing rod comprising a blank, a handle attached to the end of the blank opposite the rod tip, at least one sensor capable of sensing deflection of said blank, and generating signals representative of said deflection, a logic circuit which processes signals generated by said at least one sensor and controls a device which provides a mechanical or electrical indication representative of said deflection through the handle to a user of the fishing rod.

2. The active fishing rod of claim 1 further comprising a filter for filtering signals generated by said at least one sensor.

3. The active fishing rod of claim 1 wherein said device which provides a mechanical or electrical indication is a vibrating motor.

4. The active fishing rod of claim 1 wherein said device which provides a mechanical or electrical indication is a solenoid.

5. The active fishing rod of claim 3 wherein said vibrating motor causes the handle to move in a way that emulates in an accentuated fashion movement of the rod tip.

6. The active fishing rod of claim 4 wherein said solenoid causes the handle to move in a way that emulates in an accentuated fashion movement of the rod tip.

7. The active fishing rod of claim 1 wherein said at least one sensor is a strain gauge.

8. The active fishing rod of claim 1 wherein said at least one sensor is a bend sensor.

9. The active fishing rod of claim 1 wherein said at least one sensor is a piezo-electric sensor.

10. The active fishing rod of claim 1 having a plurality of sensors, one of said sensors indicating deflection of said blank with respect to a first axis and another of said sensors indicating deflection of said blank with respect to a second axis.

11. The active fishing rod of claim 1 comprising a plurality of sensors each associated with a separate channel.

12. The active fishing rod of claim 1 wherein at least some of said plurality of channels are coupled to a summing circuit which adds the output of said channels.
